(19) United States
(12) Patent Application Publication
(10) Pub. No.: US 2004/0120666 A1
(43) Pub. Date: Jun. 24, 2004

(54) Optical fiber ribbon having a semi-solid film on the outer surface thereof

(76) Inventors: Julie A. Chalk, Hickory, NC (US); David W. Chiasson, Hickory, NC (US); Shail K. Moorjani, Conover, NC (US); Mark T. Paap, Hickory, NC (US); Christopher M. Quinn, Hickory, NC (US)

Correspondence Address: CORNING CABLE SYSTEMS LLC, P O BOX 489, HICKORY, NC, 28603, US

(21) Appl. No.: 10/325,539

(22) Filed: Dec. 20, 2002

(51) Int. Cl. G02B 6/44

(52) U.S. Cl. 385/114

(57) ABSTRACT

A fiber optic ribbon and methods of manufacturing the same include a plurality of optical fibers arranged in a generally planar configuration with a matrix generally connecting the plurality of optical fibers. A semi-solid film being disposed on at least a portion of an outer surface of the fiber optic ribbon, thereby reducing the surface adhesion of the fiber optic ribbon. During manufacturing, the semi-solid film can be applied before or after curing the matrix using suitable methods. The method of manufacturing also includes manufacturing a fiber optic ribbon stack and a tube assembly.

### FIELD OF THE INVENTION

The present invention relates generally to fiber optic ribbons. More specifically, the invention relates to fiber optic ribbons having a semi-solid film on a surface thereof.

### BACKGROUND OF THE INVENTION

Fiber optic ribbons include optical waveguides such as optical fibers that transmit optical signals, for example, voice, video, and/or data information. Optical fiber ribbons generally have a plurality of adjacent optical fibers arranged in a generally planar configuration that are connected by a matrix material. Fiber optic ribbons have advantages over loose optical fibers such as robust packaging and mass fusion splicing. Moreover, a plurality of optical fiber ribbons can be stacked, thereby forming a dense array of optical fibers. Likewise, fiber optic cables using optical fiber ribbon stacks can result in a relatively high optical fiber-density.

One type of fiber optic cable configuration includes an optical fiber ribbon stack disposed within a tube. Generally speaking, the tube protects the optical fiber ribbon stack. However, due to bending of the tube, the optical fiber ribbons of the stack must move relative to adjacent optical fiber ribbons in the stack. For example, as the tube is bent, the individual ribbons move relative to each other to accommodate the different bending radii of ribbons in the fiber optic ribbon stack. However, the matrix material of an optical fiber ribbon generally has a relatively high surface adhesion with respect to the matrix material of an adjacent optical fiber ribbon, thereby inhibiting relative movement between the optical fiber ribbons. If adjacent ribbons are inhibited from relative movement, then the resulting stresses and/or strains can cause optical attenuation in the optical fibers. To aid in overcoming this effect, optical fiber ribbon stacks have used messy oils or thixotropic materials such as grease between optical fiber ribbons of a stack to assist relative movement therebetween. For example, U.S. Pat. No. 6,256,439 discloses lubricating oils such as polyalphaolefin oil, or a mineral oil, to permit relative movement between optical fiber ribbons. However, the lubricating oils are relatively messy and require pumps and other equipment to apply the same to the optical fiber ribbons.

### SUMMARY OF THE INVENTION

The present invention is directed to a fiber optic ribbon including a plurality of optical fibers being arranged in a generally planar configuration, a matrix generally connecting the plurality of optical fibers, and a semi-solid film being disposed on at least a portion of an outer surface of the fiber optic ribbon, thereby reducing the surface adhesion of the fiber optic ribbon.

The present invention is also directed to a method of forming a fiber optic ribbon including paying off a plurality of optical fibers, connecting the plurality of optical fibers with a matrix material, thereby forming a fiber optic ribbon, and applying a semi-solid film to an outer surface of the fiber optic ribbon.

The present invention is further directed to a method of forming a ribbon stack including paying off a plurality of fiber optic ribbons, applying a semi-solid film to at least one outer surface of at least one of the plurality of fiber optic ribbons, and stacking the plurality of fiber optic ribbons, thereby forming the ribbon stack.

Additionally, the present invention is directed to a fiber optic tube assembly including at least one optical waveguide having a core, a cladding and at least one coating, a semi-solid film, the semi-solid film disposed outward of the at least one coating, and a tube housing at least a portion of the at least one optical waveguide.

### BRIEF DESCRIPTION OF THE FIGURES

FIG. 1 is a cross-sectional view of an optical fiber ribbon according to the present invention.

FIG. 2 is a cross-sectional view of a fiber optic ribbon according to another embodiment of the present invention.

FIG. 3 is a schematic representation of an exemplary manufacturing process of the fiber optic ribbon of FIG. 1 according to the present invention.

FIG. 4 is a schematic representation of an exemplary semi-solid film application station according to the present invention.

FIG. 5 is a cross-sectional view of a fiber optic ribbon stack according to the present invention.

FIG. 6 is a schematic representation of an exemplary manufacturing process of the fiber optic ribbon stack of FIG. 5 according to the present invention.

FIG. 7 is a cross-sectional view of a tube assembly according to the manufacturing process of FIG. 6.

FIG. 8 is a cross-sectional view of a fiber optic ribbon according to another embodiment of the present invention.

FIG. 9 is a schematic representation of another exemplary semi-solid film application station according to the present invention.

### DETAILED DESCRIPTION OF THE INVENTION

The present invention will now be described more fully hereinafter with reference to the accompanying drawings showing preferred embodiments of the invention. The invention may, however, be embodied in many different forms and should not be construed as limited to the embodiments set forth herein; rather, these embodiments are provided so that the disclosure will fully convey the scope of the invention to those skilled in the art. The drawings are not necessarily drawn to scale but are configured to clearly illustrate the invention.

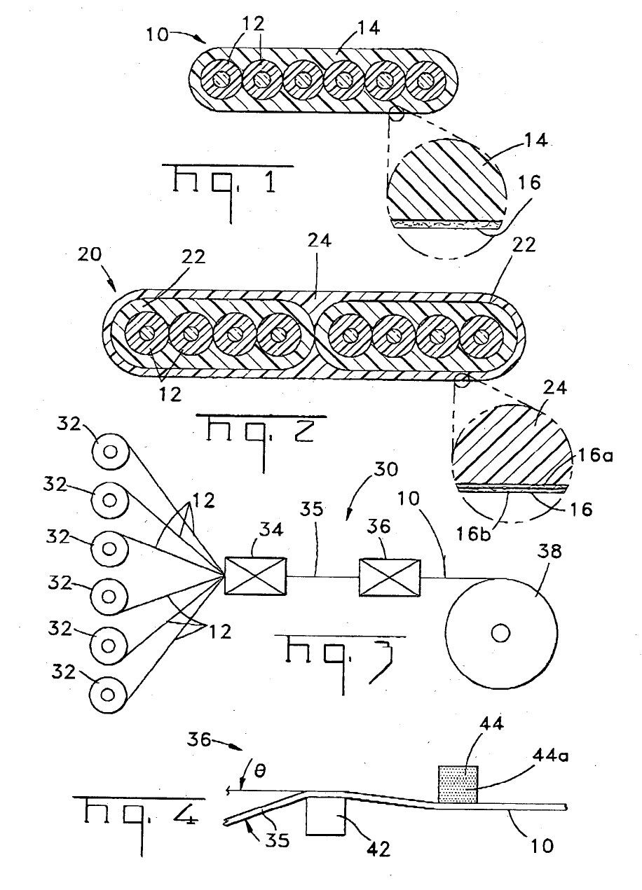

Illustrated in FIG. 1 is a fiber optic ribbon 10 according to the present invention. Fiber optic ribbon 10 (hereinafter ribbon) includes a plurality of optical waveguides, for example, optical fibers 12 arranged in a generally planar configuration with a primary matrix 14, thereby forming an elongate ribbon structure. Primary matrix 14 generally contacts and connects optical fibers 12 and may encapsulate the same, thereby providing a robust structure for processing and handling. Ribbon 10 can, for example, be used as a stand-alone ribbon, a portion of a ribbon stack, or as a subunit of a larger ribbon. Semi-solid film or layer 16 is formed from at least one semi-solid material that is disposed on a portion of the outer surface of ribbon 10. As used herein, semi-solid film means a material being in a solid or semi-solid state at ambient temperature (about 25° C.) and generally excludes powders and liquids such as oils and thixotropic greases; however, certain amounts of additives, for example talc, microspheres, silicone oils, and/or mineral oil can be suspended within the semi-solid film 16. Semi-solid film 16 is a relatively thin layer, preferably, having a thickness on the order of about 100 microns or less.

Semi-solid film 16 can, for instance, advantageously lower surface adhesion between adjacent ribbons in a stack of ribbons, thereby allowing sliding contact and relative movement between ribbons during bending. Semi-solid film 16 can include materials such as waxes, surfacants such as soap, or glycols such as propylene glycol; however, other suitable materials can be used. As used herein, wax means waxes as defined in the “Concise Chemical and Technical Dictionary,” 3^{rd} enlarged edition, said definition being incorporated by reference herein. For instance, suitable waxes can include insect waxes, vegetable waxes, mineral waxes, petroleum waxes, microcrystalline waxes, synthetic waxes, or combinations thereof.

Moreover, the semi-solid film can also include additives that are organic or non-organic. For example, additives such as silicone oil or mineral oil can be added in relatively small amounts to act as flow agents; however, any suitable oil can be used. In one embodiment, semi-solid film 16 is a paraffin wax available from Gulf Lite & Wizard Inc. under the tradename GulfWax®. By way of example, semi-solid film 16 can include other additives in the form of powders such as a graphite material therein to further reduce a coefficient of friction (COF) for layer 16. Preferred embodiments have a semi-solid film COF of about 0.8 or lower with respect to itself, more preferably about 0.5 or lower, and most preferably about 0.3 or lower. Additionally, a predetermined COF ratio between matrix 14 and semi-solid film 16 is possible. The COF ratio is preferably about 1 or greater, but other suitable COF ratios are possible. For example, the COF of matrix 14 is about 0.5 and the COF of semi-solid film 16 is about 0.25 for a COF ratio of about 2.

The hardness of semi-solid film 16 is measured using a penetration test (ASTM D1321). The penetration test measures the depth of penetration of a specially configured and weighted needle in tenths of a millimeter (dmm) at specific temperatures. Low penetration numbers indicate a relatively hard semi-solid film. Semi-solid films 16 of the present invention have a penetration range of about 1 dmm or more at 25° C. and the values of dmm generally increase with temperature. For example, a carnauba wax has a penetration of about 2 dmm at 25° C. and about 3 dmm at about 43° C.

Additionally, semi-solid film 16 can include more than one layer as shown in FIG. 2. For instance, semi-solid film 16 can use two different layers, with each layer providing different characteristics or functions of the semi-solid film 16. For example, a first layer 16a is disposed on a portion of matrix 14 is a material that is highly resistant to moisture such as a paraffin wax, thereby protecting the optical fibers from moisture. A second layer 16b is disposed over the first layer 16a and/or matrix 14 and is a material that provides the desired COF properties.

In one embodiment, optical fibers 12 are a plurality of single-mode optical fibers; however, other types or configurations of optical fibers can be used. For example, optical fibers 12 can be multi-mode, pure-mode, erbium doped, polarization-maintaining, other suitable types of light waveguides, and/or combinations thereof. For instance, each optical fiber 12 can include a silica-based core that is operative to transmit light and is surrounded by a silica-based cladding having a lower index of refraction than the core. Additionally, one or more coatings can be applied to optical fiber 12. For example, a soft primary coating surrounds the cladding, and a relatively rigid secondary coating surrounds the primary coating. Optical fibers 12 can also include an identifying means such as ink or other suitable indicia for identification. Semi-solid films of the present invention are disposed outward of the coating and/or ink layers of the optical fiber. Suitable optical fibers are commercially available from Corning Incorporated of Corning, N.Y.

Primary matrix 14 can be, for example, a radiation curable material or a polymeric material; however, other suitable materials can be used. As known to one skilled in the art, radiation curable materials undergo a transition from a liquid to a solid when irradiated with predetermined radiation wavelengths. Before curing, the radiation curable material includes a mixture of formulations of, for example, liquid monomers, oligomer “backbones” with acrylate functional groups, photoinitiators, and other additives. Typical photoinitiators function by: absorbing energy radiated by the radiation source; fragmenting into reactive species; and then initiating a polymerization/hardening reaction of the monomers and oligomers. Generally, as a result of irradiation, a cured solid network of cross-linking is formed between the monomers and oligomers, which may include fugitive components. Stated another way, the photoinitiator begins a chemical reaction that promotes the solidification of the liquid matrix into a material having characteristics of a solid polymer.

Thus, the degree of cure affects the mechanical characteristics through the cross-link density of the radiation curable material. For example, a significantly cured material can be defined as one with a relatively high cross-link density. Further, an undercured material may be defined as one having a relatively low cross-link density. The cured UV material has a modulus, for example, in the range of about 50 MPa to about 1500 MPa depending on the radiation dose. Different modulus values can provide varying degrees of performance with respect to, for example, matrix COF, hand separability of the fibers from the matrix, and robustness of the ribbons of the present invention.

In one embodiment, a UV curable material is used for primary matrix 14. For example, the UV curable material is a polyurethane acrylate resin commercially available from DSM Desotech Inc. of Elgin Ill. such as 950-706. Alternatively, other suitable UV materials can be used, for example, polyester acrylate resin commercially available from Borden Chemical, Inc. of Columbus, Ohio. Additionally, thermoplastic materials such as polypropylene or PVC can be used as a matrix material.

FIG. 2 illustrates a ribbon 20 employing the concepts of the present invention with a ribbon having subunits. Ribbon 20 includes a plurality of subunits 22 held together by a secondary matrix 24 having a layer 16 on at least a portion of the outer surface thereof. Subunits 22 include optical waveguides, for example, optical fibers 12 arranged in a generally planar configuration with a primary matrix (not numbered) connecting optical fibers 12. Secondary matrix 24 generally contacts subunits 22 and may encapsulate the same, thereby providing a robust structure for processing and handling. However, embodiments of the present invention can include ribbons having other configurations. For example, ribbons can have other suitable numbers of optical fibers or subunits. Furthermore, secondary matrix 24 can have material characteristics that are different from primary matrix 22 such as different modulus values.

Additionally, ribbons employing concepts of the present invention can have other suitable materials, characteristics, and/or geometry. For instance, ribbons can employ the concepts of U.S. patent application Ser. No. 10/159,730 filed on May 31, 2002, the contents of which are incorporated herein by reference. Additionally, as disclosed in U.S. Pat. No. 6,253,013, which is incorporated herein by reference, an adhesion zone can be used between primary matrix 22 and secondary matrix 24. For example, the adhesion zone is applied to the primary matrix of subunit 22 using a Corona discharge treatment. Additionally, a marking indicia can be printed either on the primary matrix or the secondary matrix for identification of the ribbon. Preferably, the marking indicia are disposed below semi-solid layer 16, rather than being disposed on layer 16.

FIG. 3 schematically illustrates an exemplary manufacturing line 30 for ribbon 10 according to the present invention. Manufacturing line 30 includes a plurality of payoff reels 32 having optical fibers 12 thereon, a matrix application station 34, a semi-solid film application station 36, and a take-up reel 38. During manufacture, optical fibers 12 are paid-off payoff reels 32 and fed into matrix application station 34 where optical fibers 12 are aligned and fed into a die where a matrix material is applied thereto. Next, the matrix material is cured, thereby forming matrix 14. For example, if the matrix material is a UV curable matrix material, then the curing process requires a UV lamp at an appropriate power setting to properly cure the matrix material, thereby creating a ribbon 35 without layer 16. Thereafter, ribbon 35 is fed into semi-solid film application station 36 to apply layer 16; however, in other embodiments the application of layer 16 can occur before curing of the matrix material. Layer 16 can be applied in several different ways using suitable methods and/or devices. For instance, a simple contact method applies layer 16 to cured ribbon 35 by running the same across a wax block, thereby transferring wax to cured ribbon 35.

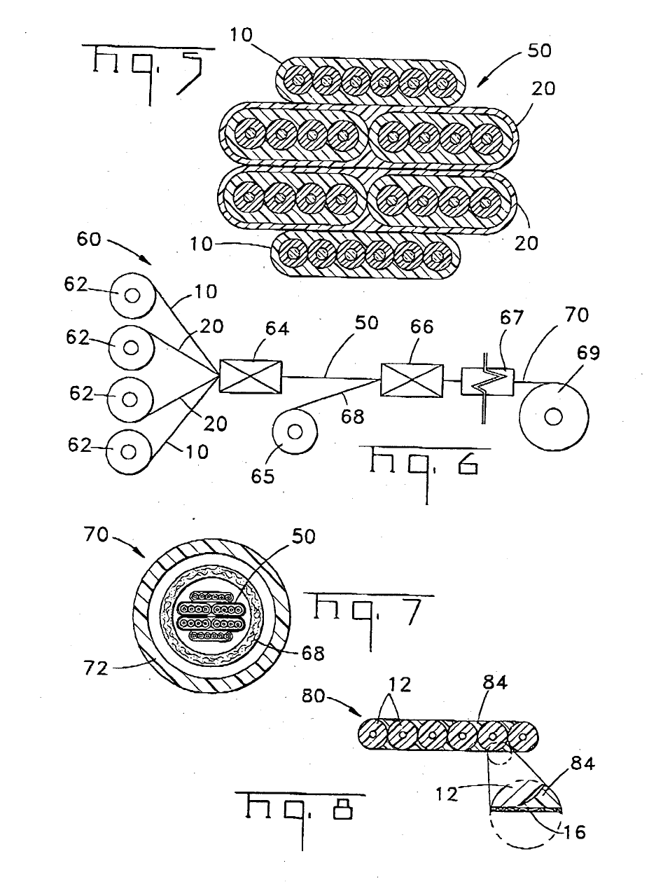

Illustratively, an exemplary semi-solid film application station 36 is schematically depicted in FIG. 4. More specifically, a first planar surface of ribbon 35 is run across a first block of paraffin wax 42 at an angle θ under tension, thereby depositing a layer about 100 microns or less thereto, preferably about 15 microns or less. Likewise, downstream the ribbon is run across a second block of paraffin wax 44 depositing a layer on the opposing planar surface of ribbon 35. Preferably, the friction between ribbon 35 and the blocks of wax 42,44 should be sufficient to deposit a predetermined amount of wax on the ribbon surface for the wax selected. Then, ribbon 10 is wound onto a take-up reel 38. The amount of semi-solid material applied to the ribbon surface can depend on factors such as the angle θ, the tension on the ribbon, the material temperature, and/or the material hardness. For example, a ribbon can be run across wax with a tension of about 300 grams at angle of about ten degrees. In other embodiments, layer 16 is applied to the ribbon in a separate process such as during the formation of a ribbon stack. In still other embodiments, the layer 16 can be applied to a single planar surface of a ribbon.

As depicted in FIG. 4, further novel embodiments of the present invention include the application of semi-solid materials having one or more additives 44a therein. Additives can be used for a variety of purposes such as tailoring flow properties for easier application of the material, improved water repellency, tailoring COF, and/or other suitable purposes. For example, a powder additive such as talc or graphite can be suspended in a semi-solid material for tailoring the COF of the semi-solid film. Additionally, additives can also include super absorbent polymers for water-blocking functions. Other variations of the concepts of the present invention include fluorinated waxes that provide water-repellancy characteristics to layer 16. Further suitable additives include microspheres such as silicone spheres, but other suitable microspheres can be used. A suitable silicone microsphere is Tospearl® 145 available from GE Plastics. However, certain microspheres may cause attenuation concerns and may not be suitable with the concepts of the present invention. For instance, relatively hard materials and/or relatively large spheres may not be desirable due to microbending concerns that cause optical attenuation. Thus, any suitable additive or additives can be suspended in the semi-solid material, thereby tailoring desired properties of a semi-solid film.

Additionally, other suitable contact or non-contact methods of applying layer 16 are possible. Contact methods means that the semi-solid material is applied by direct physical contact with an applicator or material. For instance, the ribbons can be run across a heated roller having a thin layer of semi-solid material thereon. On the other hand, non-contact methods do not have any contact between the ribbon and applicator. For instance, the semi-solid film can be applied to a ribbon using a print head 90 as shown in FIG. 9. Using this method, the semi-solid material is heated above ambient temperature and applied to the ribbon. Moreover, the semi-solid film applied by the non-contact print head can be applied before or after the matrix material is cured. Other suitable application methods can include spraying or applying the same using a die. FIG. 5 depicts a ribbon stack 50 using a plurality of ribbons 10,20 according to the present invention. As depicted, ribbon stack 50 uses ribbons of having different widths, thereby imparting a stepped profile to the ribbon stack. A stepped profile for the ribbon stack, preferably, removes optical fibers from the corner locations of the ribbon stack allowing a larger freespace between the corner locations and a tube that houses the ribbon stack. This larger freespace aids in inhibiting corner fiber attenuation in the ribbon stack. Of course, the ribbon stack can include ribbons having about the same width. Ribbon stack 50 includes at least one ribbon having a layer of a semi-solid film on at least a portion thereof. Ribbon stack 50 can also include other suitable components such as a binder (not shown) for holding the stack together. Additionally, ribbon stack 50 can be a portion of a tube assembly and/or fiber optic cable.

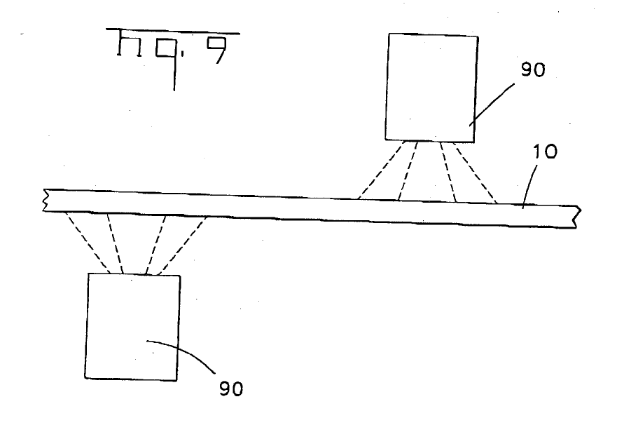

FIG. 6 schematically illustrates an exemplary manufacturing line 60 for packaging ribbon stack 50 according to the present invention. Manufacturing line 60 includes a plurality of payoff reels 62, a closing die 64, an optional element payoff reel 65, a cross-head extruder 66, a water trough 67, and a take-up reel 69, thereby forming a tube assembly 70 (FIG. 7). In this explanatory manufacturing line, ribbons 10,20 already include a semi-solid film 16; however, semi-solid film 16 can be applied at this line before the closing die 64 or in an off-line operation such as during a printing operation. For instance, the formation of a ribbon stack can include the steps of paying off a plurality of fiber optic ribbons. Next, a semi-solid film is applied to at least one outer surface of at least one of the plurality of fiber optic ribbons, and then stacking the plurality of fiber optic ribbons, thereby forming the ribbon stack.

In the manufacturing line of FIG. 6, ribbons 10,20 are paid-off payoff reels 62 and fed into closing die 64 where ribbons 10,20 are aligned in an adjacent relationship, thereby forming ribbon stack 50. Additionally, ribbon stack 50 can be stranded by suitable means (not shown) before cross-head extruder 66 or have a binder thread wrapped therearound. If a dry tube assembly, i.e., not filled with grease, is desired, ribbon stack 50 can include the addition of one or more optional elements 68. For instance, optional elements 68 within the tube assembly include water-swellable tape(s) or yarn(s). Moreover, optional elements 68 can also include one or more friction elements to provide coupling between ribbon stack 50 and a tube 72. Frictional elements include plugs, tapes, filaments, or other suitable elements. Next, ribbon stack 50 and any optional elements 68 are fed into cross-head extruder 66. Cross-head extruder 66 includes a suitable tip and die assembly, thereby forming a suitably sized tube 72 around ribbon stack 50 and any other optional element(s) 68. Finally, tube 72 is cooled in water trough 67 before a winding tube assembly 70 onto take-up reel 69. Additionally, ribbons of the present invention are suitable in other tube assembly configurations such as grease filled tube assemblies; however, due their dry characteristics the ribbons of the present invention are advantageous for dry tube assembly configurations. FIG. 7. depicts a cross-sectional view of an exemplary tube assembly 70 manufactured by manufacturing line 60.

FIG. 8 depicts another embodiment according to the present invention. In this embodiment, adjacent optical fibers 12 are connected generally at their medial portions by matrix 84, thereby forming ribbon 80. In this embodiment, instead of layer 16 being applied solely to an outer surface of the matrix, layer 16 is applied to an outer surface of optical fiber 12 and/or matrix 84. As shown, matrix 84 can be generally flush with optical fibers 12 or recessed below the plane formed by aligned optical fibers 12.

Many modifications and other embodiments of the present invention, within the scope of the appended claims, will become apparent to a skilled artisan. For example, ribbons, or subunits, can include different numbers of optical fibers, ribbons can have more than two subunits, or the ribbons can have other suitable configurations. Additionally, ribbons of the present invention can include other suitable components such as ripcords or strength members therein. Therefore, it is to be understood that the invention is not limited to the specific embodiments disclosed herein and that modifications and other embodiments may be made within the scope of the appended claims. Although specific terms are employed herein, they are used in a generic and descriptive sense only and not for purposes of limitation. The invention has been described with reference to silica-based optical fibers, but the inventive concepts of the present invention are applicable to other suitable optical waveguides and/or cable configurations as well. For instance, ribbons of the present invention are suitable for use in slotted core cables.

That which is claimed:

1. A fiber optic ribbon comprising:
a plurality of optical fibers, the plurality of optical fibers being arranged in a generally planar configuration;
a matrix, the matrix generally connecting the plurality of optical fibers; and
a semi-solid film, the semi-solid film being disposed on at least a portion of an outer surface of the fiber optic ribbon, thereby reducing the surface adhesion of the fiber optic ribbon.

2. The fiber optic ribbon of claim 1, the semi-solid film having an additive.

3. The fiber optic ribbon of claim 1, the semi-solid film being a wax.

4. The fiber optic ribbon of claim 3, the wax having an additive.

5. The fiber optic ribbon of claim 3, the wax being a paraffin wax.

6. The fiber optic ribbon of claim 2, the additive being selected from the group of graphite, talc powder, oil and microspheres.

7. The fiber optic ribbon of claim 1, the outer surface of the fiber optic ribbon being formed by the matrix.

8. The fiber optic ribbon of claim 1, the matrix being a secondary matrix.

9. The fiber optic ribbon of claim 1, further comprising at least one subunit.

10. The fiber optic ribbon of claim 1, the fiber optic ribbon being a portion of a ribbon stack.

11. The fiber optic ribbon of claim 9, the ribbon stack having fiber optic ribbons with different numbers of optical fibers.

12. The fiber optic ribbon of claim 1, the fiber optic ribbon having a coefficient of friction (COF) of about 0.8 or less.

13. The fiber optic ribbon of claim 1, the fiber optic ribbon being a portion of a tube assembly.

14. The fiber optic ribbon of claim 1, the semi-solid film being formed from at least a first layer and a second layer.

15. The fiber optic ribbon of claim 1, the semi-solid film having an ASTM 1321 penetration of about 1 dmm or more.

16. The fiber optic ribbon of claim 1, a coefficient of friction (COF) ratio between the matrix and the semi-solid film being about 1 or greater.

17. A method of forming a fiber optic ribbon comprising:
paying off a plurality of optical fibers;
connecting the plurality of optical fibers with a matrix material, thereby forming a fiber optic ribbon; and
applying a semi-solid film to an outer surface of the fiber optic ribbon.

18. The method of claim 17, the semi-solid film having an additive.

19. The method of claim 18, the additive being selected from the group of graphite, talc powder, oil, and microspheres.

20. The method of claim 17, the semi-solid film being a wax.

21. The method of claim 20, the wax having an additive.

22. The method of claim 17, the wax being a paraffin wax.

23. The method of claim 17, further comprising curing the matrix material before applying the semi-solid film.

24. The method of claim 17, further comprising curing the matrix material after applying the semi-solid film.

25. The method of claim 17, the outer surface of the fiber optic ribbon being the matrix material.

26. The method according to claim 17, the outer surface of the fiber optic ribbon being a secondary matrix.

27. The method according to claim 17, the outer surface of the fiber optic ribbon having a coefficient of friction (COF) of about 0.8 or less.

28. The method according to claim 17, the step of applying comprising applying a first layer and a second layer.

29. The method according to claim 17, the semi-solid film having an ASTM 1321 penetration of about 1 dmm or more.

30. The method according to claim 17, a coefficient of friction (COF) ratio between the matrix and the semi-solid film being about 1 or greater.

31. A method of forming a ribbon stack comprising:
paying off a plurality of fiber optic ribbons;
applying a semi-solid film to at least one outer surface of at least one of the plurality of fiber optic ribbons; and
stacking the plurality of fiber optic ribbons, thereby forming the ribbon stack.

32. The method of claim 31, the applying step comprising contacting the at least one fiber optic ribbon with the semi-solid film.

33. The method of claim 31, the applying step comprising applying the semi-solid film by a non-contact method.

34. The method of claim 31, the semi-solid film having an additive.

35. The method of claim 34, the additive being selected from the group of graphite, talc powder, oil, and microspheres.

36. The method of claim 31, the semi-solid film being a wax.

37. The method of claim 36, the wax having an additive.

38. The method of claim 31, the semi-solid film being a wax.

39. The method of claim 31, at least some of the plurality of fiber optic ribbons having different numbers of optical fibers.

40. The method of claim 31, the at least one outer surface having a coefficient of friction of about 0.8 or less.

41. The method of claim 31, the method further comprising extruding a buffer tube around the ribbon stack, thereby forming a tube assembly.

42. The method of claim 41, the method further comprising paying off an element selected from the group of a water-swellable element, a binder, and a frictional element.

43. The method according to claim 31, the step of applying comprising applying a first layer and a second layer.

44. The method according to claim 31, the semi-solid film having an ASTM 1321 penetration of about 1 dmm or more.

45. A fiber optic tube assembly comprising:
at least one optical waveguide, the at least one optical waveguide having a core, a cladding and at least one coating;
a semi-solid film, the semi-solid film disposed outward of the at least one coating; and
a tube, the tube housing at least a portion of the at least one optical waveguide.
